(19) United States
(12) Patent Application Publication
(10) Pub. No.: US 2005/0265354 A1
(43) Pub. Date: Dec. 1, 2005

(54) Method and apparatus for enabling link local address system to communicate with outer system

(75) Inventor: Seok Ryu, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/123,045

(22) Filed: May 6, 2005

(30) Foreign Application Priority Data
May 7, 2004 (KR) 10-2004-0032233

(51) Int. Cl. H04L 12/56

(52) U.S. Cl. 370/395.52

(57) ABSTRACT

A method and an apparatus are provided which enable a local system using a link local address to communicate with an external system. The local system can communicate with the external system by using a MAC address of a router found through an ARP packet. The local system transfers an ARP packet for the external system to a sub network by designating an IP address of a default gateway as an IP address of the local system.

### CROSS-REFERENCE TO RELATED APPLICATION

This application claims priority from Korean Patent Application No. 10-2004-0032233 filed on May 7, 2004 in the Korean Intellectual Property Office, the disclosure of which is incorporated herein by reference in its entirety.

### BACKGROUND OF THE INVENTION

1. Field of the Invention

The present invention relates to a method and an apparatus for enabling a link local address system to communicate with an external system, and more particularly to a method and an apparatus for enabling a link local address system to communicate with an external system in order to solve a problem of shortage of IP addresses.

2. Description of the Prior Art

Transmission Control Protocol/Internet Protocol (TCP/IP) is a basic communication protocol of the Internet and is used in private networks such as an Intranet or an Extranet. When a user sets up a computer in order to access to the Internet, a TCP/IP program is activated in the computer. Through the TCP/IP program, the user can receive or transmit messages and information from/to other users who use computers having the same TCP/IP protocol. TCP/IP is a program consisting of two layers. TCP, which is an upper layer, may transfer the messages or files through Internet by dividing messages or files into several small packets, and then, reassembles received packets into original messages. IP, which is a lower layer, may process an address part of each packet such that each packet can be precisely transferred to a destination. Further, each gateway of a network checks addresses of messages in order to find systems to which the messages will be transferred. If one message is divided into several packets, each of the packets can be delivered through mutually different routes and is reassembled into one message at a final destination. TCP/IP primarily performs point-to-point communication, which means that communication is achieved between one point (or a system) and another point (or another system) of a network.

An upper layer application protocol employing TCP/IP includes HTTP (hyper text transfer protocol) used for web services, Telnet which allows a user to log on remote computers, FTP (file transfer protocol) which is used for transferring files, and SMTP (simple mail transfer protocol) which is used for transferring mail. IP must know a destination address, to which each packet will be transmitted, in order to deal with an address part of each packet, and the destination address is called “IP address”. Each system must have the IP address for a TCP/IP connection. A currently available Internet address scheme is IPv4 (Internet Protocol Version 4) consisting of 32 bits. However, as the Internet has been rapidly growing, problems are incurred in that IPv4 addresses are insufficient. Recently, IPv6 (Internet protocol version 6) has been developed, but many problems must be solved in order to adopt the IPv6 as the Internet address scheme. Accordingly, alternative plans for efficiently using insufficient IP addresses in the IPv4 scheme are required, and, in order to resolve shortage of IP addresses, an Network Address Translation (NAT) scheme has been provided.

In the meantime, simple IP addresses for homes or offices are set by using Dynamic Host Configuration Protocol (DHCP) or a link local address. Herein, the DHCP is a protocol for allowing network administrators to centrally manage and assign IP addresses to a network of an organization. According to the TCP/IP protocol of the Internet, each computer must have a specific IP address in order to access to Internet. When computer users access the Internet in an organization, an IP address must be assigned to each computer. If DHCP is not employed, an IP address must be manually assigned into each computer. Also, a new address must be assigned into each computer if the computer moves to another location belonging to another part of the network. At this time, since DHCP allows each computer to obtain an IP address from a DHCP server, each computer employing DHCP must be connected to a server.

In contrast to DHCP, a local system employing the link local address does not connect to a server, but uses a randomly selected address. At this time, the local system adjusts an address through an Address Resolution Protocol (ARP) packet in order to avoid collision of IP addresses within a subnet. Accordingly, the local system is more efficient than a DHCP scheme because the local system is not necessary to be connected to the server. However, in order to communicate with an external device, the local system need to send data to a router. However, the local system cannot know a router address. As a result, the local system cannot communicate with the external device.

### SUMMARY OF THE INVENTION

Illustrative, non-limiting embodiments of the present invention overcome the above disadvantages and other disadvantages not described above. Also, the present invention is not required to overcome the disadvantages described above, and an illustrative, non-limiting embodiment of the present invention may not overcome any of the problems described above.

According to an aspect of the present invention, a method and an apparatus are provided which enable a local system using a link local address to communicate with an external system.

A second aspect of the present invention is to provide a method and an apparatus enabling a local system to communicate with an external system so as to resolve shortage of IP addresses.

According to an exemplary embodiment of the present invention, a method for enabling a local system to communicate with an external system comprises the steps of: receiving an ARP request packet transmitted from the local system; determining whether an IP address, which is a parameter of the ARP request packet, is an address of the external system; and transmitting an ARP response packet by a MAC address as a parameter of the ARP response packet if the IP address is the address of the external system.

According to another exemplary embodiment of the present invention, a method for enabling a local system to communicate with an external system comprises the steps of: storing an IP address of the external system as a parameter of an ARP request packet; transmitting the ARP request packet; receiving an ARP response packet for an ARP request; extracting a MAC address which is a parameter of the ARP response packet; and transmitting a data packet to be transmitted to the external system by storing the MAC address in a destination MAC address of the data packet.

According to an exemplary embodiment of the present invention, an apparatus enabling a local system to communicate with an external system comprises: an ARP processing unit receiving an ARP request packet for an external IP address and making a response by using a MAC address thereof; an address transforming unit for transforming a source IP address of a data packet received from a local system into an IP address of the apparatus if a MAC address of the data packet received from a local system is a MAC address of a router and a destination IP address of the packet is the external IP address; a data transmitting unit for transmitting a transformed packet to an external system; and an information storing unit for storing a number of a port transmitting the packet and an IP address of the local system.

According to an exemplary embodiment of the present invention, a local system comprises an ARP processing unit for storing an IP address of an external system in a parameter of an ARP request packet and extracting a MAC address which is a parameter of an ARP response packet for the ARP request packet; and a data transmitting unit for transmitting data by storing the extracted MAC address as a MAC address of the external system.

### BRIEF DESCRIPTION OF THE DRAWINGS

The above and other aspects of the present invention will be more apparent from the following detailed description taken in conjunction with the accompanying drawings, in which:

FIGS. 1A and 1B are views showing an NAT function;

FIGS. 2A and 2B are views showing a method of resolving shortage of IP addresses through NAT;

FIG. 3 is a schematic view showing a construction of local systems using link local addresses and forming a subnet;

FIG. 4 is a flow chart showing a procedure of providing an IP address to a local system by using a link local address;

FIG. 5 is a schematic view showing a procedure of changing values of an IP address and a MAC address when transmitting data packets;

FIG. 6 is a flow chart showing a communication procedure between link local systems and external systems according to an exemplary embodiment of the present invention;

FIG. 7 is a view showing a structure of a local system according to an exemplary embodiment of the present invention.

FIG. 8 is a view showing a structure of a router according to an exemplary embodiment of the present invention; and

FIG. 9 is a view showing a relationship between protocols forming a router according to an exemplary embodiment of the present invention.

### DETAILED DESCRIPTION OF EXEMPLARY EMBODIMENTS OF THE PRESENT INVENTION

Hereinafter, exemplary embodiments of the present invention will be described in detail with reference to the accompanying drawings.

Advantages and features of the present invention, and methods for achieving them will be apparent to those skilled in the art from the detailed description of the exemplary embodiments together with the accompanying drawings. However, the scope of the present invention is not limited to the exemplary embodiments disclosed in the specification, and the present invention can be realized in various types. The described exemplary embodiments are presented only for completely disclosing the present invention and helping those skilled in the art to completely understand the scope of the present invention, and the present invention is defined only by the scope of the claims. Additionally, the same reference numerals are used to designate the same elements throughout the specification and drawings.

Hereinafter, terms used in the present application will be described.

“Subnet” is abbreviation of “sub-network”. The subnet is a network included in a certain organization, but is regarded as one part separated from the network. Generally, one subnet can represent all computers within one area, one building, or the same local area network (LAN). A network of a certain organization, which is divided into several subnets, may access to Internet by using one shared network address. If there is no “subnet”, the organization must access to Internet from each of physically separated sub-networks with their own address. As a result, Internet addresses with limited numbers may be wasted.

Internet is a network for allowing users to communicate with each other. In order to communicate, it is necessary to provide a source network and a destination network relating to both users or both systems communicated with each other. In addition, computers must have specific addresses used in the network. Herein, the addresses are called “IP addresses”. The IP address consisting of 32 bits is mainly divided into two parts. One part is a network ID for identifying a network, and the other part is a system ID for identifying a specific computer or a specific system in the network. A certain organization can use parts of bits of addresses for identifying a computer or a system in order to confirm a specific subnet. Therefore, actually, it is assumed that the IP address has three parts including a network ID, a subnet ID, and a system ID.

A 32-bit address (4 bytes) for matching with a physical network address in order to efficiently perform routing over a network is an IP address. If the IP address is employed, a unique system over a network is identified, and the network including the system can be identified. The IP address is classified into classes A, B, C, D, and E.

The IP address is mainly divided into a network ID and a system ID. An address of the class A is assigned to a network having a large number of systems. The first bit of the address of the class A is always set to ‘0’, and the remaining 7 bits included in the first octet represent the network ID. Also, the remaining 24 bits, which are included in the last three octets, represent the system ID. The address of the class A can be assigned to 126 networks and 16, 777, 214 systems for each network. An address of the class B is employed for a middle-scale network or a large-scale network. The first two bits of the address of the class B are always assigned to ‘10’ in binary, and the remaining 14 bits, which belong to the first two octets, and the remaining 16 bits, which belong to the last two octets, represent a network ID and a system ID, respectively. The address of the class B can be assigned for 16,384 networks and 65,534 systems for each network. An address of the class C is used for a small-scale network. The first three bits of the address of the class C are always set to ‘110’ in binary, and the next 21 bits, which belong to the first three octets, and the remaining 8 bits, which belong to the last octet, represent a network ID and a system ID, respectively. The address of the class C can be assigned for 2,097,152 networks and 254 systems for each network. An address of the class D is used for IP multicast. The first four bits of the address of the class D are always set as ‘1110’ in binary, and the remaining bits are used as an address value to be recognized by a concerned system. An address of the class E is an experimental field remaining in order to be used in the future, and the first four bits of the class E address are always set as ‘1111’ in binary.

Besides the above IP address, which is a logical address, a Media Access Control (MAC) address can be provided as a physical address. In a local area network, the MAC address is used in a MAC layer of a data link layer and refers to a 48-bit hardware address of a network card. Also, the MAC address is identical to an Ethernet address or a token ring address. A hardware address given by a network card manufacturing companies is a universally administered address, and all network cards have unique values.

When a server receives messages via the Internet or other networks, a port number is used for recognizing a specific process to which the messages must be delivered. The port number has the form of a 16-bit integer inserted into a header added to a unit message in TCP and UDP. The port number is continuously delivered by passing between transfer layers of a client and a server in logical view and passing between a transfer layer and an Internet layer in physical view.

For example, a request delivered to an Internet server from a client may be for requiring a file provided by an FTP server of a system. In order to delivery a request of a user to an FTP process of a remote server, a TCP software layer in a user computer checks a port number ‘21’ included in a 16-bit integer port number added through the request, in which the port number ‘21’ is generally used in relation to an FTP request. In a server, a TCP layer reads data through the port number ‘21’ and delivers the request of the user to an FTP program of the server.

Permanent port numbers are typically assigned to some services. However, the port number is temporarily assigned to other services within the range of available port numbers when other services request the port numbers.

A packet means a binary group, that is, a bit group including data and network control signals. In particular, when data are transmitted through a packet-switch method, the data are divided into several packets, which are basic transmission units, and then, divided data are reassembled into original data.

A router is a unit for connecting separated networks employing the same transmission protocol and connects network layers of the separated networks to each other. The router determines nodes provided in a network relating to the router, or determines nodes provided in another network according to a routing table in addition to functions of a bridge. Also, the router selects the best route of several routes so as to transfer packets. In addition, the router controls a data flow, constructs several sub-networks within a network, and performs various management functions of the network. Regarding difference between a bridge and a router, the router has functions in a range of a network layer and establishes routes of data, and the bridge has functions in a range of a data link layer and selects destination addresses and determines simple routes of data.

Although the router is described as an exemplary embodiment in the specification, the scope of the present invention is not limited to the router, but may be employed for all apparatus for transmitting/receiving data of a subnet to/from external networks.

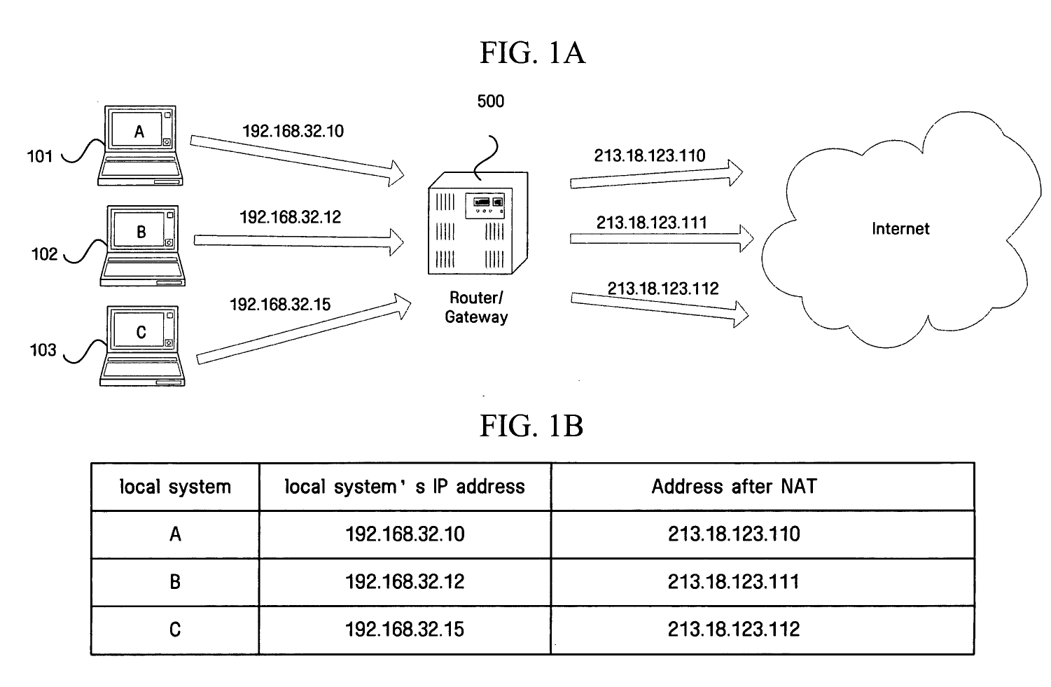

FIGS. 1A and 1B show views relating to NAT. As described above, the NAT is used for resolving shortage of IP addresses. The NAT means that an IP address different from an IP address known to external networks is used in a subnet. Also, the NAT refers to transformation into an IP address different from the IP address when the subnet makes communication with external networks. The NAT is performed in a router 500 shown in FIGS. 1A and 1B. Local systems A 101, B 102, and C 103 shown in FIGS. 1A and 1B form one subnet and use IP addresses “192.168.32.10”, “192.168.32.12”, and “192.168.32.15”, respectively, in the subnet. However, the router 500 transmits data with different IP addresses through the NAT in order to communicate with a public network. FIGS. 1A and 1B shows that the local systems A 101, B 102, and C 103 communicate with the public network by using different IP addresses “213.18.123.110”, “213.18. 123.111”, and “213.18.123.112”, respectively. The public network recognizes IP addresses of the local systems A 101, B 102, and C 103 as “213.18.123.110”, “213.18.123.111”, and “213.18.123.112” so that security is achieved with respect to the local systems A 101, B 102, and C 103 and IP addresses are easily managed in view of a subnet management.

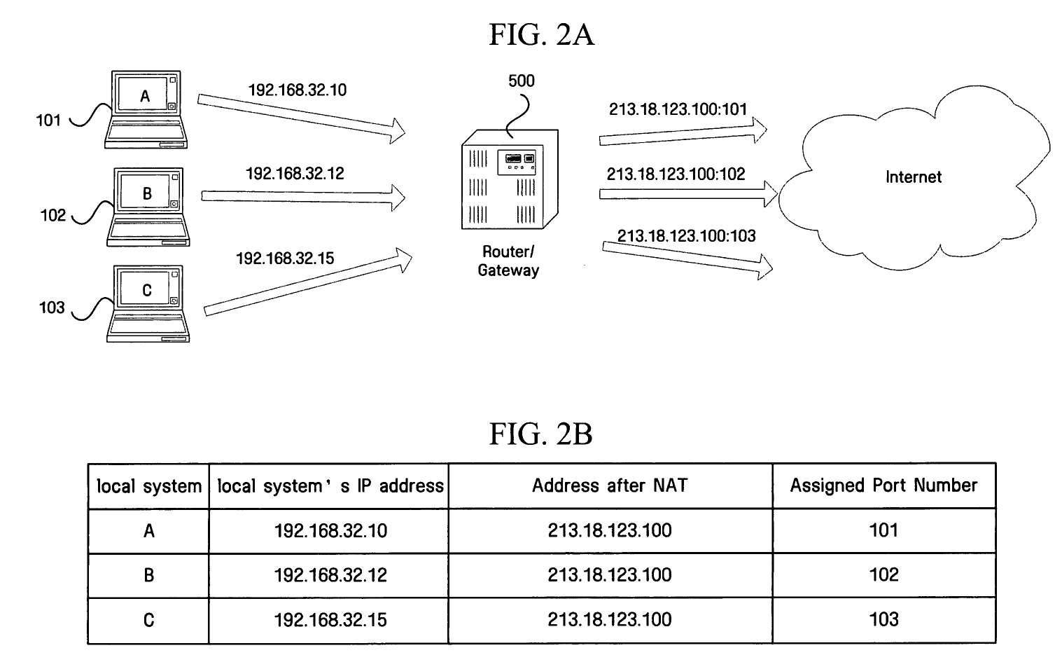

FIGS. 2A and 2B show a method of resolving shortage of IP addresses described above through the NAT. The local systems A 101, B 102, and C 103 shown in FIGS. 2A and 2B have IP addresses “192.168.32.10”, “192.168.32.12”, and “192.168.32.15”, respectively, in a subnet as shown in FIGS. 1A and 1B. However, the local systems can communicate with the public network by using one IP address having distinguished port numbers, other than three IP addresses. The local systems A 101, B 102, and C 103 are connected to port numbers 101, 102, and 103 of an IP address “213.18.213.110”, which is determined by the router 500. Also, the local systems A 101, B 102, and C 103 communicate with the public Internet through the port numbers 101, 102, and 103. Since class A can use IP addresses of “10.0.0.0” to “10. 255.255.255”, class B can use IP addresses of “172.16.0.0” to “172.31.255.255”, and C can use IP addresses of “192.168.0.0” to “192.168.255.255” in one subnet, respectively, although such IP addresses uniquely exist in one subnet unit, the same IP address may exist in another subnets. For example, an IP address of “192.168.1.2” may exist in a subnet G and a subnet H. Therefore, although plural systems exist in a subnet, IP addresses can be economically used because the number of IP addresses used is smaller than that of the systems.

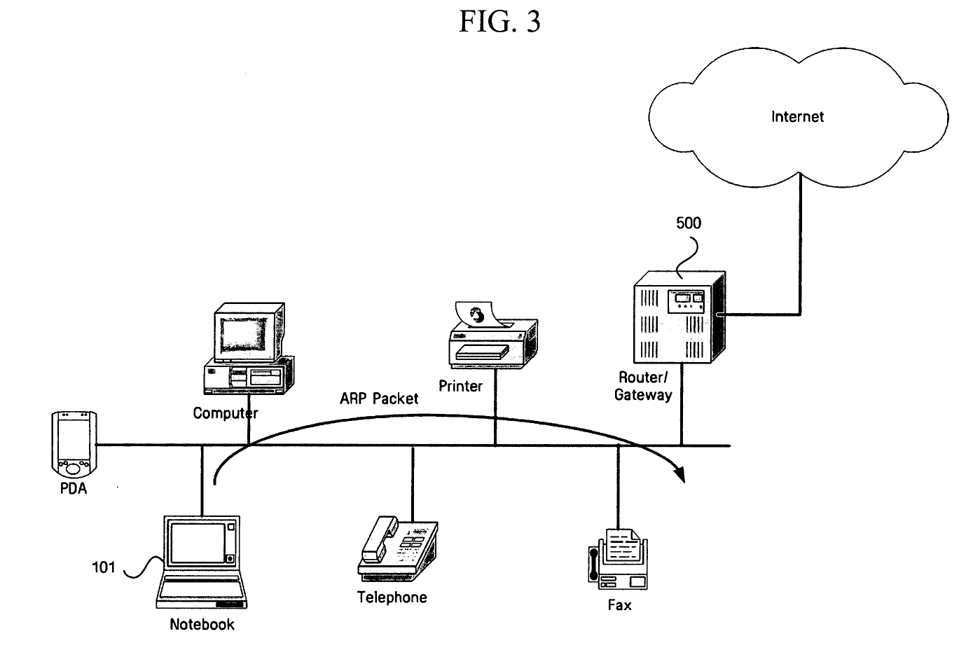

FIG. 3 is a schematic view showing a construction of local systems using link local addresses and forming a subnet. In order to construct the subnet, an internal IP address described above has to be assigned and a server mediating IP addresses is required. However, when local system only communicates with other local system in the subnet, a procedure of accessing the server in order to receive the internal IP address may be an overhead. To solve the above-mentioned problem, a method of employing the link local address has been suggested. The link local address is a communication method in which a local system included in the subnet randomly selects specific lower bits of an IP address without an additional access to the server so as to perform communication by using the IP address having randomly selected lower bits as an IP address of the local system. However, if an IP address identical to the selected IP address exists in a corresponding subnet, a collision occurs. Therefore, in order to avoid the collision, the link local address allows the local system to employ an ARP protocol and to check whether there is another local system using a corresponding IP address. After that, if the local systems using the corresponding IP address do not exist, the local system uses the corresponding IP address as an IP address of itself.

The ARP is used for requesting a physical address of a system having an IP address. The ARP maps an IP address (an address on a network layer) into a hardware address (an address on a data-link layer; a MAC address). Herein, an IP address is a logical address and may be varied depending on network configuration, but a physical address becomes an unchangeable address. Accordingly, if a certain system sends an ARP packet to a certain user's IP address, a response is made based on the physical address of the user. As shown in FIG. 3, if a notebook 101, which is a local system, transmits an ARP packet to local systems in the subnet, a local system having a corresponding IP address transmits a MAC address thereof to the notebook 101. Then, the notebook 101, which has transmitted the ARP packet, selects another IP address and transmits an ARP packet. If a response to the ARP packet does not exist, the notebook 101 can perform communication by using the selected IP address because there is no system using the selected IP address.

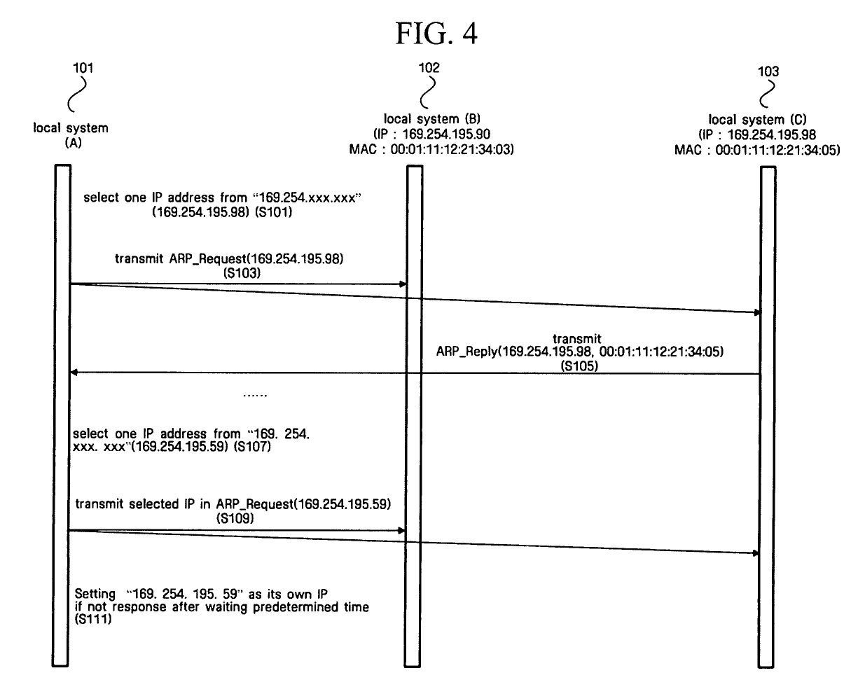

FIG. 4 is a view showing a procedure through which the local system 101 obtains an IP address by using the link local address. The local system 101 selects one IP address from “169.254.xxx.xxx”. The IP address can be selected at random or in a predetermined method. The local system 101 shown in FIG. 4 selects an IP address “169.254.195.98” in operation S101 and transmits the selected IP address as a parameter of an ARP_Request packet in operation S103. If local systems 102 and 103 in a subnet, which have received the ARP_Request packet, determine that an IP address of the ARP_Request packet is identical to their IP address, the local systems 102 and 103 send an ARP_Reply packet by employing their MAC address as a parameter of the ARP_Reply packet. In an example shown in FIG. 4, the local system 103 responds to the ARP_Request packet by setting a MAC address of the local system 103 as a parameter of the ARP_Reply packet in operation S105. The local system 101 having received the response to the ARP_Request packet detects that there is a local system using a corresponding IP address. Then, the local system 101 selects an IP address from “169.254.xxx.xxx” in operation S107, and then, transmits the selected IP address by employing the selected IP address as a parameter of an ARP_Request packet in operation S109. If an ARP_Reply is not received for a predetermined time through the procedure described above, the local system 101 performs communication by using the selected IP address as its own IP address in operation S111 because there are no systems using the selected IP address.

A problem of the link local address is incurred in that local systems employing the link local address cannot communicate with the public network. In particular, the local systems cannot find a router address or a gateway address because the local systems communicate through randomly selected IP address. However, since a router or a gateway must be gone through in order to communicate with the exterior of the local system, a method in which the local systems find the router address or the gateway address so as to communicate is required. Before solving the problem, functions of an IP address and a physical address in telecommunication will be described below.

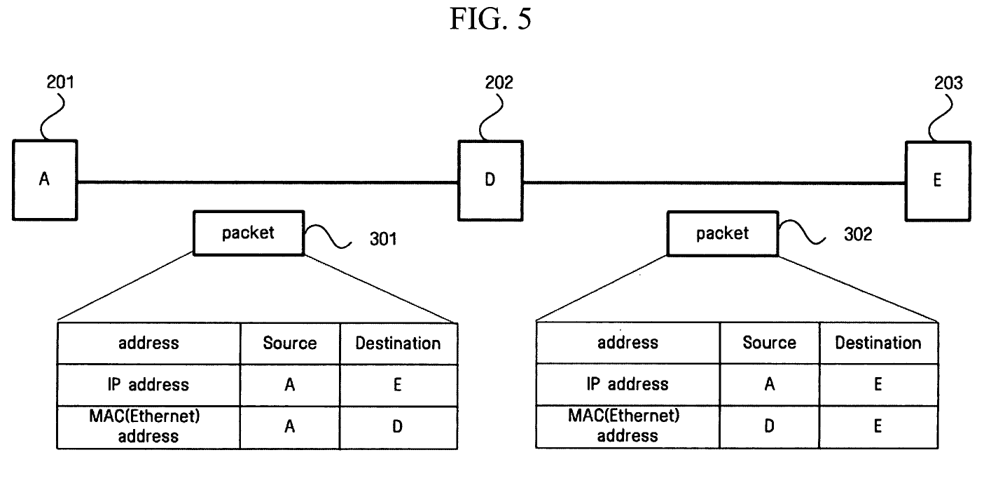

Hereinafter, values of the IP address and the MAC address when transmitting data packets will be described with reference to FIG. 5. The IP address is a logical address and the MAC address is a physical address of an appliance. Accordingly, if a computer A 201 transmits data packets to a computer E 203, a source address and a destination address are “A” and “E”, respectively. However, the MAC address varies depending on computers through which the data packets pass. Herein, if the computer A 201 is not directly connected to the computer E 203, the data packets are transmitted through another computers. FIG. 5 shows a structure in which an IP packet is transmitted to the computer E 203 through a computer D 202. A format of a packet 301, which is transmitted to the computer D 202 by the computer A 201 for transmitting the IP packet 301 to the computer E 203 is as follows. Although a source and a destination of IP addresses of the IP packet 301 are “A” and “E”, respectively, MAC addresses of the IP packet 301 are recorded with addresses of the computer A 201 and the computer D 202 through which the IP packet 301 are transferred. The computer D 202 having received the IP packet 301 transmits the IP packet 301 to the computer E 203 again because the MAC addresses of the IP packet 301 are addresses for the computer D 201, but the IP addresses are not addresses for the computer D 201. In this procedure, the MAC addresses of the IP packet 301 change. Herein, since the packet is transmitted between the computer D 202 and the computer E 203 again after packet transmission between the computer A 201 and the computer D 202 is finished, a source and a destination of the MAC addresses are “D” and “E”, respectively. Herein, the IP addresses are constantly “A” and “E”.

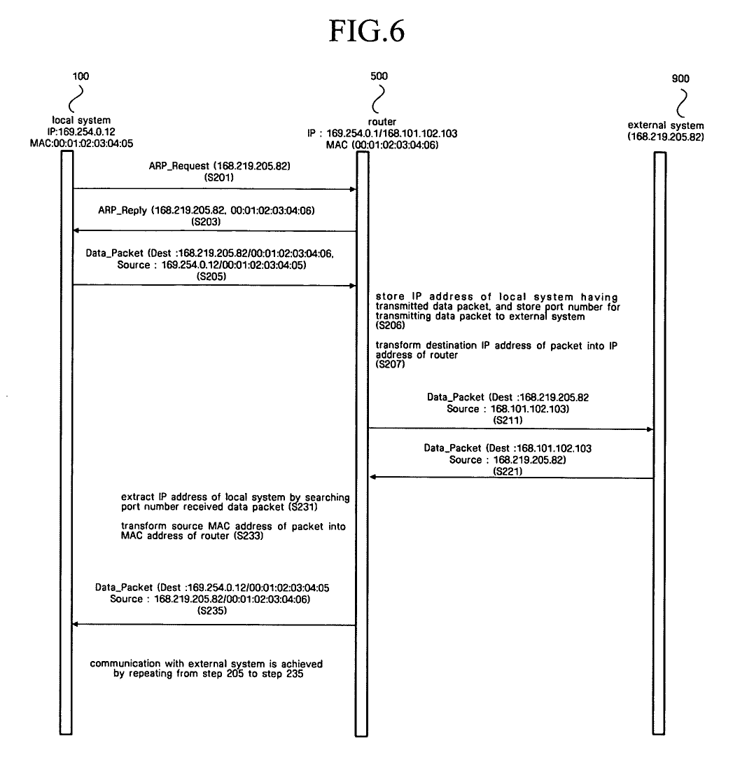

FIG. 6 is a view showing a procedure through which link local systems communicate with external systems according to an exemplary embodiment of the present invention. Herein, it is assumed that a local system 100 has obtained an IP address through the procedure described with reference to FIG. 4. When the local system 100 is intended to communicate with an external system 900, the local system 100 stores information about an IP address of the external system 900 in a parameter of an ARP_Request packet so as to transmit the ARP_Request packet in operation S201. A router having received the ARP_Request packet determines whether the ARP_Request packet relates to a system located in the exterior of a subnet. After that, if the ARP_Request packet relates to the external system, the router transmits a physical address of the router (hereinafter, simply referred to as “MAC address”) in operation S203. The local system 100 receiving an ARP_Reply packet transmits a data packet in which a MAC address of the external system 900 is set as a MAC address of the router 500 receiving the ARP_Request packet in operation S205. Then, the router 500 performs an operation for transmitting the data packet, which has been received in the router 500 and contains other system's IP address rather than the IP address of router 500, to the exterior of the router 500. In detail, the router 500 stores an IP address of the local system 100 having transmitted the data packet, a port number for transmitting the data packet, and an IP address of the router 500 to be used by the router 500 in operation S206. This information is used for connecting the local system 100 to the external system 500 when the external system 900 sends data as a response to the data packet so as to communicate with the local system 100 after the operation. After storing the information, the router 500 changes a source IP address of the received data packet into the IP address of the router 500 in operation S207. Through operation S207, the external system 900 recognizes the data packet as a packet transmitted by the router 500. The data packet is received by the external system 900 through Internet in operation S211. The external system 900 having received the data packet tries to communicate with the router 500 by transmitting a response packet to the router 500 as a response to the data packet in operation S221. The router 500 having received the response packet searches for an IP address of a local system communicating with the external system 900 by using the number of a port having received the response packet in operation S231. The router 500 changes a MAC address of the response packet into the MAC address of the router 500 before transmitting the response packet to the local system 100 in operation 233. After that, the router 500 transmits the response packet to the local system 100 in operation S235. After operation S235, the local system 100 can continuously communicate with the external system 900 by using the MAC address of the received response packet, that is, the MAC address of the router 500.

ARP is a protocol for finding mapping information about an IP address and a MAC address as described above. Accordingly, if a destination IP address is an IP address of an external system and not a subnet, the destination IP address is an IP address set in a default gateway. However, as described above, a local system does not know the IP address of the default gateway. According to an exemplary embodiment of the present invention, the local system sets the IP address of the default gateway as an IP address of the local system. If the local system sets the IP address of the default gateway as the IP address of the local system, the local system sends all packets excluding packets to be delivered thereto to a network. For this reason, a router connected to the subnet can receive the packets. As a result, the router can use the MAC address thereof as a response to an ARP request packet for the IP address of the external system.

A term “unit”, that is, “module” used in the exemplary embodiment means software components or hardware components such as FPGA and ASIC. Also, the module performs predetermined functions. However, the module or unit is not limited to software or hardware. The module can be formed such that the module is stored in addressable recording media. Also, the module can be formed such that one or more than processes are executed. For example, the module includes components, such as software components, object-oriented software components, class components, and task components, processes, functions, attributes, procedures, subroutines, segments of program codes, drivers, firm ware, micro-code, circuits, data, databases, data formats, tables, arrays, and variables. Herein, functions provided by the above components and modules can be achieved with a smaller number of components and modules by combining components and modules with each other, or can be achieved with a larger number of components and modules by dividing the components and the modules. In addition, components and modules may be realized such that one or more CPUs are reproduced in a device or a security multimedia card.

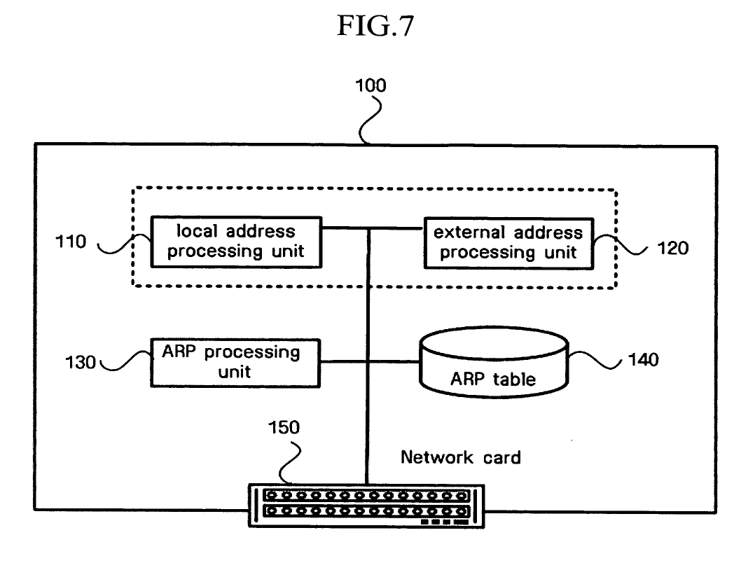

FIG. 7 is a view showing a structure of the local system 100 according to an exemplary embodiment of the present invention. The local system 100 includes a local address processing unit 110 for using a link local address and an external address processing unit 120 for communicating with the exterior of the local system 100. The local address processing unit 110 performs an operation for communicating with systems in a subnet. Also, the external address processing unit 120 performs an operation for transmitting an ARP request packet by employing an IP address of the external system as a parameter of the ARP request packet before communicating with the external system. In addition, an ARP processing unit 130 processes “ARP_Request”, which is the ARP request packet, and “ARP_Reply”, which is an ARP response packet, and stores a result of the process in an ARP table 140. The ARP table 140 is a table in which IP addresses are mapped with MAC addresses. Also, when the local system continuously makes communication with the external system, if the ARP table 140 stores a MAC address of the router 500 after transmitting the ARP_Request packet and receiving a response packet for the ARP_Request packet one time, the local system can communicate with the external system without an additional procedure of transmitting ARP_Request packet. Meanwhile, a network card transmits and receives the ARP packets and data packets, and a MAC address of the network card is a MAC address of the local system. Also, when setting the network card, a gateway is set such that an ARP_Request packet for the external system can be transmitted to the router through the subnet by means of the gateway.

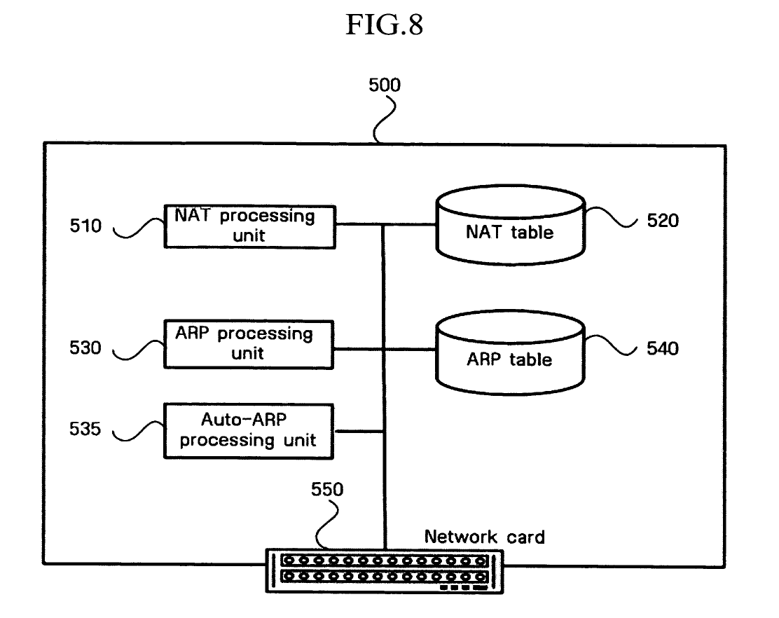

Hereinafter, a structure of the router 500 allowing the local system according to an exemplary embodiment of the present invention to communicate with the external system will be described with reference to FIG. 8. An Auto-ARP processing unit 535 transmits the MAC address of the router 500 when transmitting the ARP_Request packet by setting the IP address of the external system in an ARP_Request packet. An ARP processing unit 530 supports the ARP operation of the Auto-ARP processing unit 535. An ARP table 540 has IP addresses and MAC addresses of other local systems.

A NAT table 520 stores information about a local system having transmitted a data packet before transmitting the data packet to be received by the external system to the external system. Also, the NAT table 520 stores an IP address of the local system and a port number required for transmitting the data packet to the external system. If the external system transmits a data packet through the port number, the router transmits the data packet to a local system corresponding to the port number again.

Also, a NAT processing unit 510 is provided for modifying information about a data packet to be transmitted to the exterior of the router by using information of the router 500. The NAT processing unit 510 transmits the data packet by changing source information of the data packet into the IP address and the MAC address of the router 500, so that the exterior of the router 500 recognizes that it communicates with the router 500. Also, the NAT processing unit 510 performs an operation for transmitting a packet transmitted from the exterior of the router 500 to a corresponding local system with the NAT table 520. In addition, a network card 550 is provided for transferring the ARP packet and data packets. Herein, a MAC address of the network card 550 is a MAC address of the router 500.

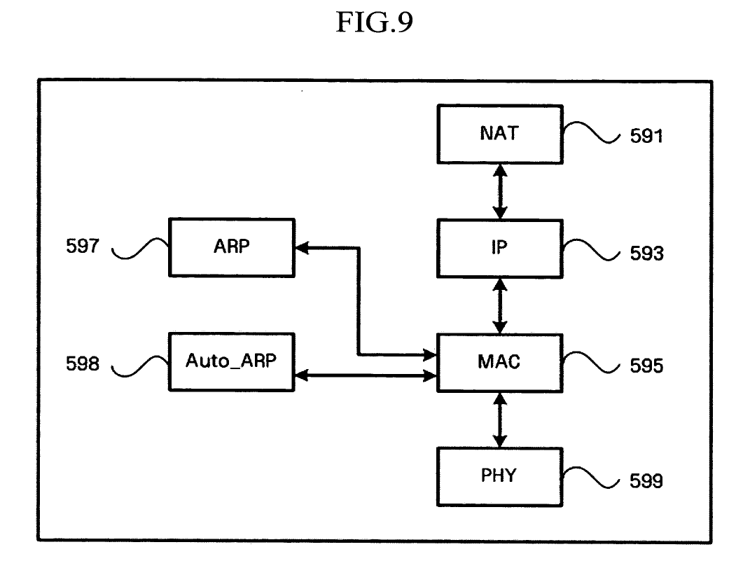

Hereinafter, mutual operations between protocols for the router 500 according to an exemplary embodiment of the present invention will be described with reference to FIG. 9. Physical layer (PHY) 599 changes data to be sent into physical signals so as to transfer the physical signals. MAC 595 is a protocol for controlling a medium, that is, a physical layer and uses the MAC address described above. IP 593 is an Internet protocol and gives a unique IP address to each system. Also, the IP 593 is a protocol for performing routing for establishing an IP packet route by using the IP address. ARP 597 is a protocol for informing a MAC address for the IP address and transmits the MAC address of the router 500 if an ARP_Request packet incoming from another system is an ARP_Request packet corresponding to the IP address of the router 500. Also, when the router 500 receives data having the MAC address of the router 500, such as “ReverseARP_Request”, the ARP 597 transmits the IP address of the router. Next, if the router 500 receives an ARP_Request packet, which has an IP address of the external system as a parameter thereof, an Auto_ARP protocol 598 automatically sends the MAC address of the router 500 as a response to the ARP_Request packet. NAT 591 transforms addresses of a network as described above. Also, when a local system is intended to communicate with the external system, the NAT 591 records an IP address of the local system and a port number of the router 500. The NAT 591 transmits a packet to the external system by employing the IP address of the router 500 as a source IP address. After that, when the external system transmits a packet through the port number of the router 500 again, the NAT 591 determines a local system, which will receive the packet, by using the port number with reference to the NAT table so as to transmit the packet to a corresponding local system.

As described above, according to an exemplary embodiment of the present invention, a local system using a link local address can communicate with an external system.

Also, according to an exemplary embodiment of the present invention, since the link local address is used, shortage of IP addresses can be resolved.

Although exemplary embodiments of the present invention have been described for illustrative purposes, those skilled in the art will appreciate that various modifications, additions and substitutions are possible, without departing from the scope and spirit of the invention as disclosed in the accompanying claims.

1. A method for enabling a local system to communicate with an external system, the method comprising:
i) receiving an Address Resolution Protocol (ARP) request packet transmitted from the local system;
ii) determining whether an Internet Protocol (IP) address, which is a parameter of the ARP request packet, is an address of the external system; and
iii) transmitting an ARP response packet by a Media Access Control (MAC) address as a parameter of the ARP response packet if the IP address is determined to be the address of the external system.

2. The method as claimed in claim 1, wherein an IP address is assigned to the local system through a link local address assignment.

3. The method as claimed in claim 1, further comprising:
iv) receiving a data packet transmitted by the local system and storing a port number to which the data packet is transmitted and the IP address of the local system in an address transformation table; and
v) transmitting the data packet to the external system by transforming a source IP address of the data packet into an IP address of a system receiving the data packet from the local system.

4. The method as claimed in claim 3, further comprising:
vi) receiving a response data packet from the external system and searching for an IP address of the local system which is stored in the address transformation table based on the port number which received the data packet; and
vii) transforming a destination IP address of the response data packet into the IP address of the local system; and
viii) transmitting the response data packet to the local system.

5. An apparatus comprising:
an Address Resolution Protocol (ARP) processing unit which receives an ARP request packet for an external IP address and generates a response by using a Media Access Control (MAC) address thereof;
an address transforming unit which transforms a source IP address of a data packet received from a local system into an Internet Protocol (IP) address of the apparatus if a MAC address of the data packet received from a local system is a MAC address of a router and a destination IP address of the packet is the external IP address;
a data transmitting unit which transmits a transformed packet to an external system; and
an information storing unit which stores a number of a port transmitting the data packet and an IP address of the local system.

6. The apparatus as claimed in claim 5, further comprising a data receiving unit which receives the ARP request packet and the data packet, wherein, if the data receiving unit receives a data packet transmitted from the external system through the number of the port, the data transmitting unit searches for a local system having an IP address, which is stored in the information storing unit with the number of the port, and transmits the data packet to the local system.

7. A method of enabling a local system to communicate with an external system, the method comprising:
i) storing an Internet Protocol (IP) address of the external system as a parameter of an Address Resolution Protocol (ARP) request packet;
ii) transmitting the ARP request packet;
iii) receiving an ARP response packet for an ARP request;
iv) extracting a Media Access Control (MAC) address which is a parameter of the ARP response packet; and
v) transmitting a data packet to be transmitted to the external system by storing the MAC address in a destination MAC address of the data packet.

8. The method as claimed in claim 7, wherein iv) includes storing the MAC address in the local system.

9. The method as claimed in claim 8, further comprising vi) transmitting the data packet by employing the stored MAC address as a destination MAC address of the data packet if the data packet is transmitted to the external system.

10. A local system comprising:
an Address Resolution Protocol (ARP) processing unit which stores an Internet Protocol (IP) address of an external system in a parameter of an ARP request packet and extracting a Media Access Control (MAC) address which is a parameter of an ARP response packet for the ARP request packet; and
a data transmitting unit which transmits data by storing the extracted MAC address as a MAC address of the external system.

11. The local system as claimed in claim 10, further comprising a storing unit which stores the MAC address, wherein the data transmitting unit transmits the data by using the MAC address of the external system if the data transmitting unit communicates with the external system after the MAC address is stored.

12. The local system as claimed in claim 10, further comprising a network card in which a default gateway is set as the local system.
